(19) United States
(12) Patent Application Publication
(10) Pub. No.: US 2010/0102661 A1
(43) Pub. Date: Apr. 29, 2010

(54) Rotating shaft for ultra slim spindle motor

(75) Inventors: Nam Seok Kim, Gyunggi-do (KR); Sang Kyu Lee, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD, Suwon (KR)

(21) Appl. No.: 12/318,274

(22) Filed: Dec. 23, 2008

(30) Foreign Application Priority Data
Oct. 24, 2008 (KR) 10-2008-0104702

(51) Int. Cl. H02K 5/167; F16C 32/06

(52) U.S. Cl. 310/90; 384/115

(57) ABSTRACT

Disclosed herein is a rotating shaft for an ultra slim spindle motor which reduces a frictional area between the rotating shaft and a bearing, thus being capable of reducing consumption current consumed during the rotation of the rotating shaft. The ultra slim spindle motor includes a rotating shaft for axially supporting a rotor casing and a bearing for rotatably supporting the rotating shaft. The rotating shaft includes a coupling part which is press-fitted into the rotor casing, upper and lower contact parts which are supported, respectively, by an upper portion and a lower portion of the bearing, and a non-contact part which is provided between the upper and lower contact parts in such a way that the non-contact part is not in contact with the bearing.

### CROSS REFERENCE TO RELATED APPLICATION(S)

This application claims the benefit of Korean Patent Application No. 10-2008-0104702, filed on Oct. 24, 2008, entitled “Rotating shaft for ultra slim spindle motor”, which is hereby incorporated by reference in its entirety into this application.

### BACKGROUND OF THE INVENTION

1. Field of the Invention

The present invention relates generally to a rotating shaft for an ultra slim spindle motor and, more particularly, to a rotating shaft for an ultra slim spindle motor which reduces a frictional area between the rotating shaft and a bearing, thus being capable of reducing consumption current consumed during the rotation of the rotating shaft.

2. Description of the Related Art

A spindle motor forms an oil film between a bearing and a rotating shaft using a lubricant, thus rotatably supporting the rotating shaft, therefore maintaining rotation characteristics of high precision. Because of these characteristics, the spindle motor has been widely used as the drive means of a hard disk drive, an optical disk drive, and other recording media requiring high-speed rotation.

Currently, in the case of a DVD disk of a half height drive for recording a DVD, the disk recording speed has a tendency to increase such that it has attained 16× to 20× or more. In order to improve the recording speed, the maximum rotating speed of the spindle motor must be 10500 RPM or more. In order to increase the rotating speed of the spindle motor, various methods have been proposed to reduce the maximum allowable current of a drive IC for the spindle motor.

One example of the spindle motor requiring the high-speed rotation is schematically shown in FIG. 9.

As shown in FIG. 9, a conventional spindle motor 400 includes a support unit and a rotating unit which is rotatably supported by the support unit.

The support unit is provided with a plate 410, a bearing holder 420, a bearing 430, and an armature 440.

The plate 410 functions to support the whole portion of the support unit, and is fixedly mounted to a device such as a hard disk drive to which the spindle motor 400 is mounted.

The bearing holder 420 serves to support the bearing 430, and has the shape of a hollow cylinder. An end of the bearing holder 420 is secured to the plate 410 through caulking or spinning.

The bearing 430 functions to rotatably support the rotating shaft 460, and is manufactured to have a cylindrical shape using metal such as copper. The bearing 430 is installed in such a way that the central axis thereof is identical with that of the rotating shaft 460. Further, a predetermined amount of lubricant is contained between the bearing 430 and the rotating shaft 460, thus allowing the rotating shaft 460 to be more smoothly rotated.

The armature 440 forms an electric field when external power is applied to the armature 440, thus rotating a rotor, and includes a core 441 and a coil 442 wound around the core 441.

The core 441 is made of a predetermined metal material and is secured to the outer circumferential surface of the bearing holder 420. The coil 442 forms the electric field with the external power, thus rotating a rotor casing 470 using a force generated between the coil 442 and a magnet 472 of the rotor casing 470.

Meanwhile, the rotating unit is provided with the rotating shaft 460 and the rotor casing 470.

The rotating shaft 460 functions to rotatably support the rotating unit relative to the support unit, and is rotatably inserted into the bearing 430 such that the central axis of the rotating shaft 460 is identical with that of the bearing 430.

The rotor casing 470 serves to mount and rotate a recording medium (not shown), and is installed to be secured to the rotating shaft 460, with a chucking assembly provided on the center of the rotor casing 470 to hold an optical disk (not shown).

Further, the magnet 472 is secured to the inner wall of the rotor casing 470 and faces the armature 440, thus generating rotating force. Here, when current is applied to the coil 442, the rotating unit is rotated by the force generated between the coil 442 and the magnet 472.

However, the conventional spindle motor 400 is constructed so that the whole outer circumferential surface of the rotating shaft 460 is supported by the bearing 430, so that a large frictional area is formed between the rotating shaft 460 and the bearing 430. Thereby, the conventional spindle motor 400 is problematic in that a larger amount of current must be applied to the drive IC and the coil 442 in order to rotate the rotating shaft 460 at high speeds.

### SUMMARY OF THE INVENTION

The present invention has been made in an effort to provide a rotating shaft for an ultra slim spindle motor, in which the rotating shaft is manufactured such that a remaining portion of the rotating shaft excluding an effective area supported substantially by a bearing during the rotation of the rotating shaft is not in contact with the bearing, thus reducing a frictional area between the bearing and the rotating shaft, therefore reducing consumption current.

In a rotating shaft for an ultra slim spindle motor according to an embodiment of the present invention, the ultra slim spindle motor includes a rotating shaft for axially supporting a rotor casing and a bearing for rotatably supporting the rotating shaft. The rotating shaft includes a coupling part which is press-fitted into the rotor casing, upper and lower contact parts which are supported, respectively, by an upper portion and a lower portion of the bearing, and a non-contact part which is provided between the upper and lower contact parts in such a way that the non-contact part is not in contact with the bearing.

The non-contact part comprises a groove formed along an outer circumference of the rotating shaft in such a way as to be stepped.

One or more non-contact parts are provided in an axial direction of the rotating shaft.

Further, a length of the non-contact part is designated such that a ratio of the length of the non-contact part to an entire length of the rotating shaft is 50% or more.

A width of the non-contact part is designated such that a ratio of the width of the non-contact part to a radius of the rotating shaft is 99% or less.

Further, a lubricant seeping from a portion of the bearing in contact with each of the upper and lower contact parts during a rotation of the rotating shaft is stored in the non-contact part.

The lubricant stored in the non-contact part is circulated to the upper and lower contact parts by capillary force.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic sectional view illustrating an ultra slim spindle motor equipped with a rotating shaft according to one embodiment of the present invention;

FIG. 2 is a partial enlarged perspective view illustrating the rotating shaft and bearing of FIG. 1;

FIGS. 3 and 4 are sectional views illustrating the rotating shaft of FIG. 1;

FIGS. 5 and 6 are sectional views illustrating rotating shafts according to other embodiments of the present invention;

FIGS. 7 and 8 are graphs illustrating the magnitude of consumption current consumed during the rotation of the rotating shaft of the present invention and the rotating speed of the rotating shaft when the same current is applied thereto; and

FIG. 9 is a schematic sectional view illustrating a conventional spindle motor.

### DESCRIPTION OF THE PREFERRED EMBODIMENTS

Hereinafter, a rotating shaft for an ultra slim spindle motor according to the preferred embodiment of the present invention will be described in detail with reference to the accompanying drawings.

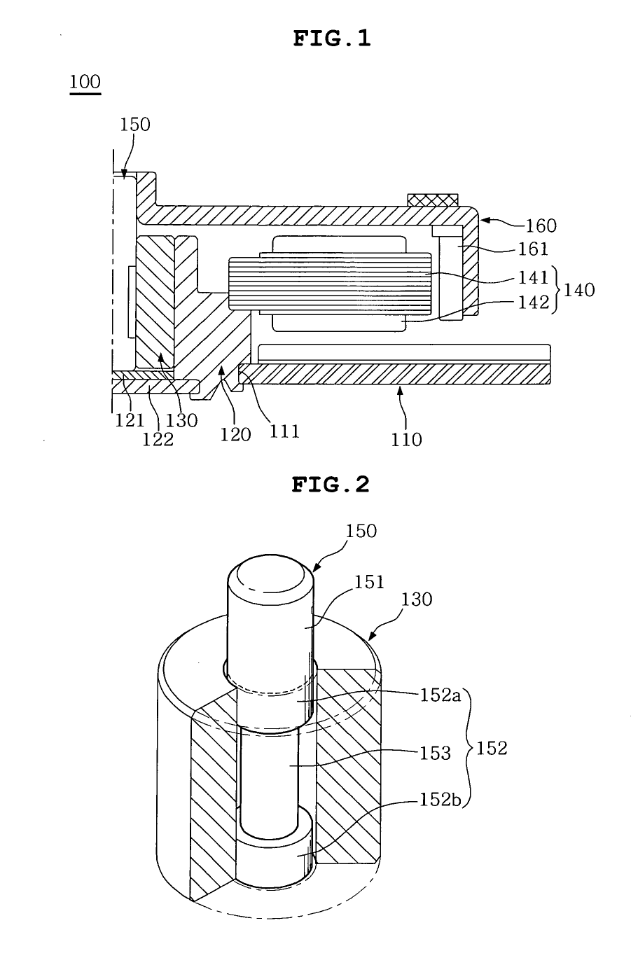

As shown in FIG. 1, the rotating shaft according to the preferred embodiment of the present invention is provided on an ultra slim spindle motor 100. The spindle motor 100 includes a support unit and a rotating unit which is rotatably supported by the support unit.

The support unit includes a plate 110, a bearing holder 120, a bearing 130 and an armature 140.

The plate 110 functions to hold the support unit such that its entirety is secured to a predetermined position, and is secured to an ODD device such as a hard disk drive to which the spindle motor 100 is mounted. Further, the plate 110 is manufactured using a lightweight material such as an aluminum or aluminum alloy plate, but may be manufactured using a steel plate, with a holder insert hole 111 formed in the central portion of the plate 110 such that the bearing holder 120 is inserted into the holder insert hole 111.

The bearing holder 120 functions to hold the bearing 130 such that it is secured at a predetermined position. After part of the bearing holder 120 is inserted into the holder insert hole 111 formed in the plate 110, an end of the bearing holder 120 is secured to the plate 110 through caulking or spinning.

Further, a thrust washer 121 for supporting an end of the rotating shaft 150 in the direction of thrust is secured to the central portion of the bearing holder 120 via a thrust washer cover 122. The thrust washer cover 122 is secured to the bearing holder 120 through caulking or spinning.

The bearing 130 functions to rotatably support the rotating shaft 150, and is manufactured using a metal material to have a cylindrical shape. According to this embodiment, the bearing 130 may be a cylindrical lubricant-impregnated sintered bearing 130. However, the manufacturing method and shape of the bearing 130 are not limited to this embodiment. That is, the bearing 130 of this embodiment may be a bearing 130 which is manufactured by mixing metal powder with lubricant and compressing/sintering the mixture, or may be a bearing 130 which is manufactured by physically processing materials of the bearing.

Further, dynamic pressure generating grooves (not shown) of various shapes may be formed at portions of the bearing 130 facing contact parts 152 of the rotating shaft 150 to generate fluid dynamic pressure. The dynamic pressure generating grooves concentrate the lubricant on a predetermined portion when the rotating shaft 150 rotates at high speeds, thus generating dynamic pressure, thereby allowing the rotating shaft 150 to smoothly rotate. Meanwhile, the dynamic pressure generating grooves may not be formed in the bearing 130 but may be formed in the rotating shaft 150.

The armature 140 forms an electric field when external power is applied to the armature 140, thus rotating the rotating shaft 150, and includes a core 141 and a coil 142 wound around the core 141.

The core 141 is installed to be secured to the outer circumference of the bearing holder 120, and may be manufactured by laminating a plurality of silicon steel plates. The coil 142 forms the electric field using external power applied to the coil 142, thus rotating a rotor casing 160 using electromagnetic force generated between the coil 142 and the magnet 161 of the rotor casing 160.

Meanwhile, the rotating unit functions to rotate a recording medium such as an optical disk (not shown), and includes the rotating shaft 150 and the rotor casing 160.

The rotating shaft 150 functions to rotatably support the rotating unit relative to the support unit, and is rotatably inserted into the bearing 130 such that the central axis of the rotating shaft 150 is identical with that of the bearing 130. An end of the rotating shaft 150 is supported by the thrust washer 121 in the direction of thrust, and part of the outer circumference of the rotating shaft 150 is rotatably supported by the bearing 130.

Further, the rotating shaft 150 includes contact parts 152 which are provided on upper and lower portions in the direction of thrust and supported by the bearing 130, and a non-contact part 153 which is provided between the contact parts 152 and spaced apart from the bearing 130. The rotating shaft 150 constructed as described above will be described in detail below with reference to FIG. 2.

The rotor casing 160 serves to mount and rotate an optical disk (not shown), and is installed to be secured to the rotating shaft 160, with a chucking assembly provided on the center of the rotor casing 160 to hold the optical disk.

Further, the magnet 161 which faces the armature 140 to generate rotating force is secured to the inner wall of the rotor casing 160. Here, when a current is applied to the coil 142, the rotating shaft 150 and the rotor casing 160 are rotated by the force generated between the coil 142 and the magnet 161.

As shown in FIG. 2, the rotating shaft 150 of this embodiment is inserted into the bearing 130 to be rotatably supported by the bearing 130, and includes a coupling part 151 which protrudes outwards from the bearing 130 and is coupled to the rotor casing 160, the contact parts 152 which are rotatably supported by the bearing 130, and the non-contact part 153 which is not in contact with the bearing 130.

The coupling part 151 has a predetermined length such that it is press-fitted into the rotor casing 160 to be secured thereto. It is preferable that the coupling part 151 be formed as short as possible, as long as the coupling part 151 is not removed from the rotor casing 160.

The contact parts 152 include an upper contact part 152a which is supported by the upper portion of the bearing 130 and a lower contact part 152b which is supported by the lower portion of the bearing 130. The upper and lower contact parts 152a and 152b are formed to have the same length substantially.

The dynamic pressure generating grooves may be formed in the contact parts 152 to generate dynamic pressure between the contact parts 152 and the bearing 130.

The contact parts 152 are in direct contact with the bearing 130 when the rotating shaft 150 rotates at first, so that frictional heat is generated between the contact parts 152 and the bearing 130. Because of the frictional heat, the lubricant seeps from the bearing 130. Afterwards, the lubricant concentrates between the contact parts 152 and the bearing 130 because of the dynamic pressure generating grooves which are formed in the contact parts 152, so that dynamic pressure is generated.

The non-contact part 153 is provided between the upper contact part 152a and the lower contact part 152b, and comprises a groove which is formed along the outer circumference of the rotating shaft 150 in such a way as to be stepped. After the rotating shaft 150 has been manufactured, the outer circumference of the rotating shaft 150 is machined using an additional machining tool, so that the non-contact part 153 may be formed. Alternatively, the non-contact part 153 may be formed simultaneously when the rotating shaft 150 is manufactured.

Such a non-contact part 153 reduces frictional force between the rotating shaft 150 and the bearing 130, thus reducing the amount of current which is consumed during the rotation of the rotating shaft 150.

Further, the non-contact part 153 is formed between the upper and lower contact parts 152a and 152b, and stores lubricant escaping from between the contact parts 152 and the bearing 130 and transmits the stored lubricant to the contact parts 152 again, thus performing a lubricant circulating function. That is, the lubricant stored in the non-contact part 153 may be transmitted to the contact parts 152 again by capillary force generated between the contact parts 152 and the bearing 130 during the rotation of the rotating shaft 150.

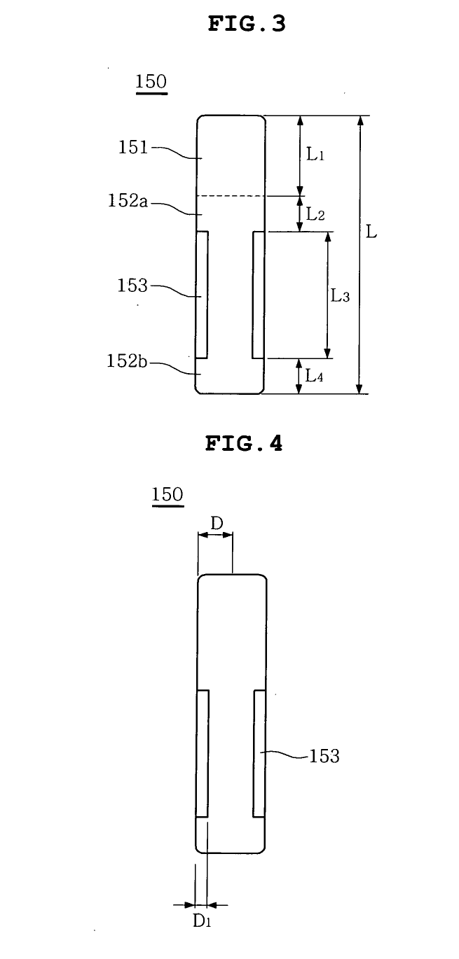

The rotating shaft 150 for the ultra slim spindle motor constructed as described above may be manufactured to have a ratio such as that shown in FIGS. 3 and 4.

As shown in FIG. 3, the rotating shaft 150 according to the preferred embodiment of the present invention includes the coupling part 151, the upper contact part 152a, the non-contact part 153 and the lower contact part 152b. When the entire length of the rotating shaft 150 is L and the length of the coupling part 151 is L₁, the upper contact part 152a has a length L₂, the non-contact part 153 has a length L₃, and the lower contact part 152b has a length L₄.

Here, the coupling part 151 has the length L₁ which allows the coupling part 151 to be firmly press-fitted into the rotor casing 160 so as to prevent the coupling part 151 from being removed from the rotor casing 160. Preferably, the upper and lower contact parts 152a and 152b have length L₂ and L₄, respectively, to prevent the rotating shaft 150 from shaking.

In the rotating shaft 150 constructed as described above, the length L₃ of the non-contact part 153 is preferably designated such that the ratio of the length L₃ of the non-contact part 153 to the entire length L of the rotating shaft 150 is ½, that is, 50% or more.

Preferably, L:L₃=2:1 (50%) or greater.

Meanwhile, as shown in FIG. 4, the rotating shaft 150 according to the preferred embodiment of the present invention has a radius D, and the non-contact part 153 has a width D1.

In the rotating shaft 150 constructed as described above, the width D₁ of the non-contact part 153 is preferably designated such that the ratio of the width D₁ of the non-contact part 153 to the radius D of the rotating shaft 150 is 99% or less.

Preferably, D:D₁=1:0.99 or less.

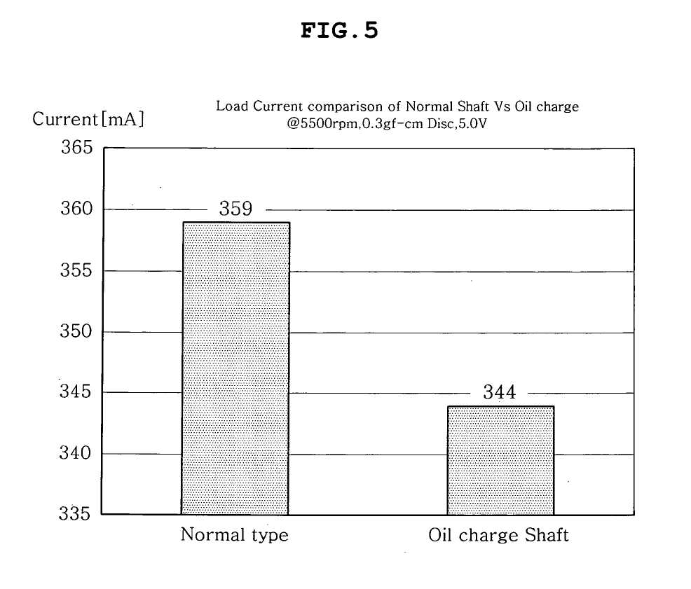

For example, as shown in FIG. 5, in the rotating shaft 150 which is 4 mm in entire length L and is 2 mm in radius D, assuming that the length L₃ of the non-contact part 153 is 2 mm and the width D₁ of the non-contact part 153 is 1.75 mm, the current of 344 mA may be consumed to rotate the rotating shaft 150 at 5500 rpm. Meanwhile, when the conventional rotating shaft which has the same length and thickness as those of the above-mentioned rotating shaft but has no non-contact part rotates at 5500 rpm, the current of 359 mA is consumed. Consequently, the present invention achieves a reduction in consumption current of about 4%.

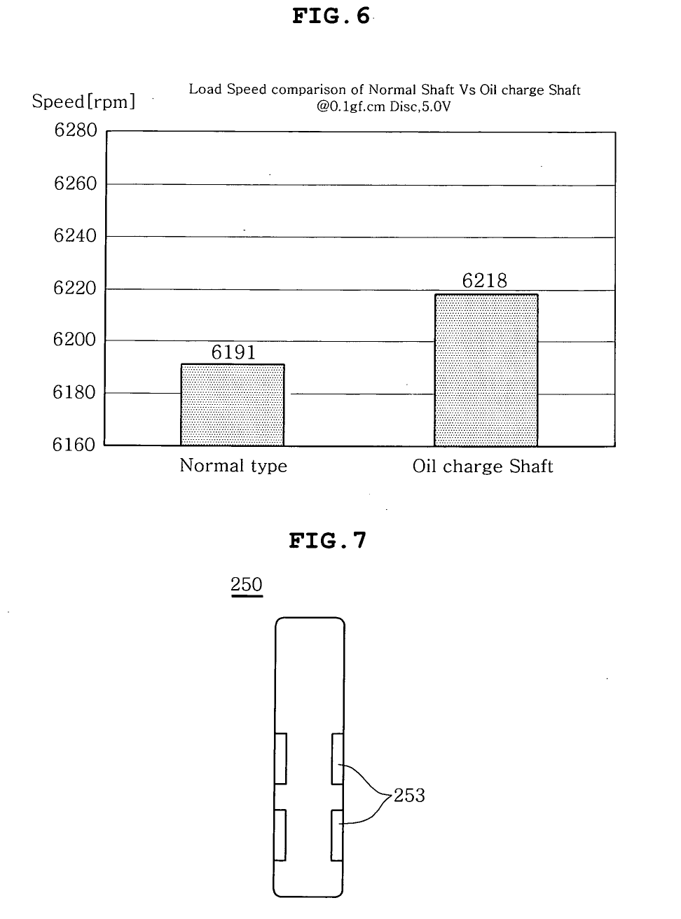

Further, as shown in FIG. 6, when the current of 430 mA is applied to the rotating shaft 150 having the above-mentioned specification, the rotating shaft 150 of the present invention can be rotated at up to 6218 rpm. In contrast, the conventional rotating shaft having the same length and thickness as those of the above-mentioned rotating shaft but having no non-contact part may rotate at up to only 6190 rpm. As a result, the rotating shaft according to the present invention achieves an increase in rotating speed of about 4%.

That is, the non-contact part 153 formed in the rotating shaft 150 reduces a frictional area between the rotating shaft 150 and the bearing 130, thus reducing the amount of current required when the rotating shaft 150 is rotated, and increasing a rotating speed with the same amount of current.

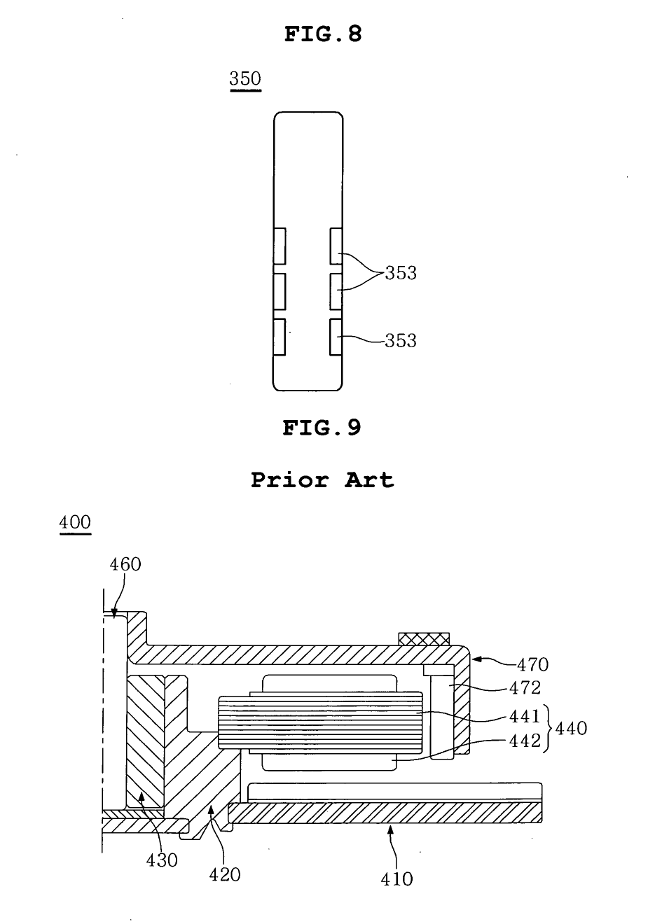

Meanwhile, as shown in FIGS. 1 to 4, one non-contact part 153 may be formed in the rotating shaft 150. However, as shown in FIG. 7 or 8, two non-contact parts 253 may be formed in a rotating shaft 250, or three non-contact parts 353 may be formed in a rotating shaft 350.

That is, the shape and number of the non-contact part is not limited to the above-mentioned embodiments, as long as the non-contact part reduces the frictional area between the rotating shaft 150 and the bearing 130, and may re-circulate lubricant leaking from the contact parts back to the contact parts again.

As described above, the present invention provides a rotating shaft for an ultra slim spindle motor, in which a non-contact part of the rotating shaft is not in contact with a bearing, so that a frictional area between the rotating shaft and the bearing is reduced, and thus consumption current required during the high-speed rotation of the rotating shaft can be reduced.

Further, the frictional area between the rotating shaft and the bearing is reduced, so that the rotating speed of the rotating shaft can be increased under the same amount of current.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A rotating shaft for an ultra slim spindle motor having a rotating shaft for axially supporting a rotor casing and a bearing for rotatably supporting the rotating shaft, the rotating shaft comprising:
a coupling part press-fitted into the rotor casing;
upper and lower contact parts supported, respectively, by an upper portion and a lower portion of the bearing; and
a non-contact part provided between the upper and lower contact parts in such a way that the non-contact part is not in contact with the bearing, a length of the non-contact part being designated such that a ratio of the length of the non-contact part to an entire length of the rotating shaft is 50% or more, and a width of the non-contact part being designated such that a ratio of the width of the non-contact part to a radius of the rotating shaft is 99% or less.

2. The rotating shaft as set forth in claim 1, wherein the non-contact part comprises a groove formed along an outer circumference of the rotating shaft in such a way as to be stepped.

3. The rotating shaft as set forth in claim 1, wherein one or more non-contact parts are provided in an axial direction of the rotating shaft.

4-5. (canceled)

6. The rotating shaft as set forth in claim 1, wherein a lubricant seeping from a portion of the bearing in contact with each of the upper and lower contact parts during a rotation of the rotating shaft is stored in the non-contact part.

7. The rotating shaft as set forth in claim 6, wherein the lubricant stored in the non-contact part is circulated to the upper and lower contact parts by capillary force.
